(19) United States
(12) Patent Application Publication
(10) Pub. No.: US 2026/0233839 A1
(43) Pub. Date: Aug. 13, 2026

(54) In-Flight Headset and Controller Mount for Aircraft Visor Rails

(71) Applicant: James Bast, Gig Harbor, WA (US)

(72) Inventor: James Bast, Gig Harbor, WA (US)

(21) Appl. No.: 19/049,978

(22) Filed: Feb. 10, 2025

(51) Int. Cl. B64D 11/00

(52) U.S. Cl. CPC B64D 11/0015

(57) ABSTRACT

Systems and methods are disclosed to secure a headset with a mount system in an aircraft by attaching a headset mount device to a visor rail in the aircraft by engaging a hook portion of the bracket with the rail, wherein the hook extends into a support arm pointing toward a cockpit window, wherein the support arm further extends into a headset retention member with a tip pointing away from the cockpit window; placing a headset on a headset retention member on the visor rail with a headset cable coupled to the support arm, wherein the headset retention member is configured to secure and balance a headset on the headset retention member. The method also optionally includes hooking a controller mount device to clip to the visor rail and securing a controller on the support arm, further comprising threading a cable between the headset and the controller through a cable support hook on the support arm.

### BACKGROUND OF THE INVENTION

Within the aviation industry, pilots often utilize various headsets for communication and noise attenuation during flight operations. Traditionally, these headsets are either placed loosely within the cockpit when not in use, stored in dedicated compartments, or hung on hooks or other makeshift holding solutions. However, these conventional storage methods may not exist or provide adequate protection for the headsets from movement during turbulence or ensure that the headset is readily accessible when needed. Furthermore, the organization and placement of headsets and their corresponding control units can impact cockpit ergonomics and efficiency. To address these concerns, innovative systems have been sought that integrate headset storage and accessibility within the confines of the aircraft cockpit. The development of a specialized system that mounts to the existing visor rails in aircraft not only optimizes the use of space but also secures the headset and associated controls, potentially improving both the safety and functionality of the cockpit environment for pilots.

### SUMMARY OF THE INVENTION

In one aspect, a headset mount device for attachment to an airplane visor rail includes a hook portion configured to engage with the visor rail; a support arm extending from the hook portion; and a headset retention member coupled to the support arm, wherein the headset retention member is configured to secure and balance a headset on the headset retention member.

In implementations, the hook portion is a curved section adapted to partially encircle the visor rail. The support arm extends substantially perpendicular to the hook portion. The headset retention member can be a substantially flat surface for supporting the headset. The headset retention member can be a flat or smooth surface, a ridge, an A-frame, or a roof shape to support the headset, and wherein the headset retention member comprises an extension or stopper at the end to prevent headset slippage. A cable support hook is provided on the support arm. An extension or stopper can be provided at one end of the support arm to prevent headset slippage.

In another aspect, a controller mount device is provided to clip to the visor rail and spaced apart from the headset mount device, the controller mount device securing a controller with a cable coupled to a cable support hook on the support arm. The controller mount device includes a hook portion configured to engage with the visor rail; a support arm extending from the hook portion; and a controller retention member coupled to the support arm, wherein the controller retention member includes a base with four arms extending therefrom to secure and balance the controller on the controller retention member. In implementations, a stop surface can be provided at the end of the base to prevent controller slippage. These implementations can be combined to integrate the support arm and retention member to the controller mount device.

Advantages of one implementation may include one or more of the following:

Enhanced Safety: By providing a dedicated and secure place for the headset and controller, the risk of these items moving around the cockpit during turbulence or sudden maneuvers is mitigated. This helps in maintaining a safer cockpit environment and ensures that critical communication devices are not damaged or displaced in situations where they might be urgently needed.

Improved Cockpit Organization: The mount system promotes a tidier cockpit by minimizing clutter. With a designated spot for the headset and controller, pilots can manage their workspace more efficiently, reducing the cognitive load that can come from operating in a disorganized area, especially during busy periods such as preflight and post flight duties when the headset is not worn but is connected to the aircraft.

Increased Accessibility: The apparatus is designed to ensure that both the headset and controller are easily reachable when necessary. Quick and easy access to communication equipment is crucial, especially in emergency situations or during critical phases of flight, such as take-off and landing.

Efficient Use of Space: Given that cockpit space is usually at a premium, one implementation utilizes the existing visor rail, which is an underutilized area, to store the headset and controller. This spares other compartments and surfaces for additional necessary equipment or personal items.

Protection of Equipment: The mount devices provide secure retention that is tailored to the headset and controller, offering better protection against the wear and tear that can occur with loosely stored items.

Cable Management: By considering the routing and management of cables between the headset and controller, one implementation can help in avoiding the tangling and snagging of wires, thereby prolonging the lifespan of the communication devices and maintaining the aesthetic appeal of the cockpit.

Customization and Compatibility: The design of the mount system can be adjusted or made with varying specifications to accommodate different types of headsets and controllers, making it a versatile solution for a wide range of aircraft models.

Reduced Pilot Distraction: With the communication equipment securely in place and cables managed neatly, pilots can focus on flying tasks without being distracted by having to reposition or untangle their headset and controller.

Enhanced Ergonomics: By ensuring that the headset and controller are strategically positioned for optimal use without requiring unnecessary reach or movement, the system potentially contributes to better ergonomics within the cockpit.

Streamlined Design: The integration of the mounting system with the visor rail provides a streamlined appearance and eliminates the need for additional brackets or fasteners that might interfere with other cockpit functions or aesthetics.

### BRIEF DESCRIPTION OF DRAWINGS

FIG. 1A-1C show various views of a headset bracket for use in an airplane cockpit.

FIGS. 2A-2E show various views of headset controller mount devices, each customized for a headset controller design.

FIGS. 3A-3C show exemplary views of controller bases and while FIGS. 4A-4D show exemplary hooks for the hand controller mount of FIGS. 2A-2D.

FIG. 5 shows an exemplary flowchart showing steps for attaching a headset mount device to a visor rail and placing a headset on a retention member.

### DETAILED DESCRIPTION OF THE INVENTION

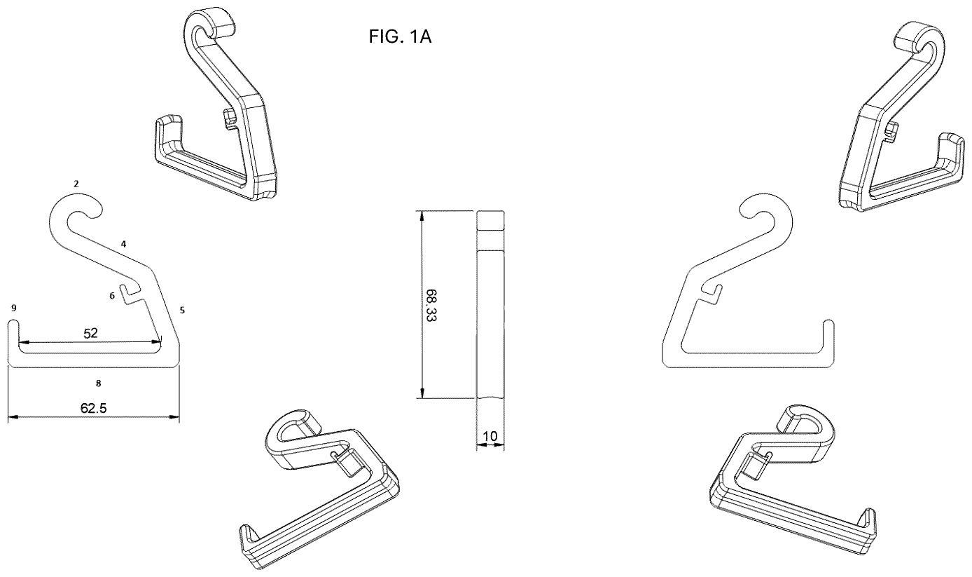

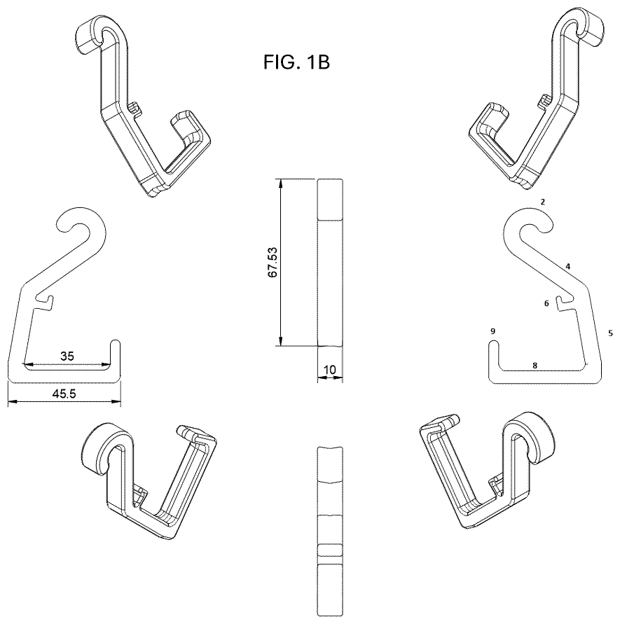

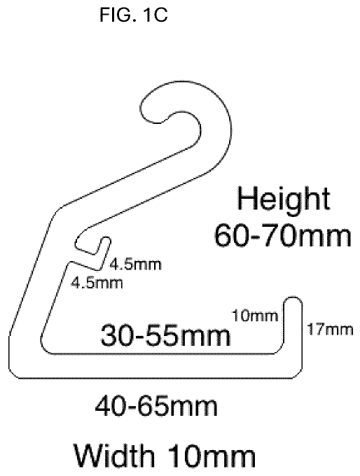

FIG. 1A-1C relate to various headset mount devices designed for installation on an aircraft's visor rail to securely hold and balance a headset when not in use by the pilot or crew. The device ensures that the headset is readily accessible while preventing damage and clutter in the cockpit.

FIG. 1A shows a first headset mount device with a right perspective view of a headset mount device or bracket, a right side view of the headset bracket a right bottom perspective view of the headset bracket, a top view of the headset bracket, a left perspective view of the headset bracket, a left side view of the headset bracket, and a left bottom perspective view of the headset bracket.

Viewing the figures together, the headset mount device for attachment to an airplane visor rail includes a hook portion 2 configured to engage with the visor rail (not shown), a support arm 4 extending from the hook portion 2; and a headset retention member 8 coupled to the support arm 4, wherein the headset retention member 8 is configured to secure and balance a headset on the headset retention member. The support arm 4 also includes a controller cable hook 6 that secures a cable from the headset to a headset controller. In the design of FIG. 1A, the inner length of the headset retention member 8 is 52 cm in length, while the corresponding outer length is 62.5 cm. FIG. 1B shows a second headset mount device the inner length of the headset retention member 8 is 35 cm in length, while the corresponding outer length is 45.5 cm. FIG. 1C shows the dimensions of various alternative headset mount devices.

In one design, the hook portion 2 of the headset mount device is crafted to precisely engage with the visor rail typically found in the cockpit of an airplane. This hook is shaped to conform to the profile of the visor rail, allowing it to be easily attached and detached when necessary while maintaining a firm grip to prevent slipping or movement during flight or when the aircraft encounters turbulence.

Extending outward from the hook portion is the support arm 4 that serves as the structural link between the hook and the headset retention element. The support arm is constructed to provide proper distance from the visor rail, positioning the headset at a convenient location for the user to reach. The support arm is oriented in such a way that it extends in the direction of one of the cockpit windows.

Attached at the end of the support arm is the headset retention member 8. It ensures the headset remains firmly positioned. The headset retention component is crafted to adapt to an extensive assortment of headset configurations, addressing various shapes and dimensions typically found in the aviation sector. In one implementation, the surface incorporates cushioning or anti-slip substances to reinforce the hold on the headset and to guard against scratches or damage when the headset is placed onto or taken off the retention member.

To maintain balance, the headset retention member 8 is positioned and shaped to support the headset at its center of gravity. This keeps the headset stable and prevents any swinging or shifting that could distract the pilot or crew during critical operations. The even weight distribution provided by this balanced support also helps preserve the durability of the headset's band and earpieces.

The hook is for hanging an aviation headset from the visor rail in an aircraft. This visor rail is a standard design and found on many different aircraft. It hooks over the rail and then naturally angles backward toward the window. The rail has a ⅝″ diameter which is the common system. The hook has a 220-235 degree closure to allow for repeated use without breaking while holding securely. It then angles downward by 45 degrees. At this angle there is a small clip to attach to the cable of the headset. After angling down to allow space for the headband, the hook uses a flat surface slightly concave to retain the headset from drooping or falling off. This is achieved by an angle back away from the window of 10-20 degrees based upon the headset size. The lip is designed to retain the headset based upon the width of its headband. This length and angle are adjustable slightly to keep the headset secure on the hook. The end of the hook has a lip to contain the headset. The retention member 8 includes at the end of the support arm upwardly pointing ends, optimized for balanced headset support. The retention member appears to extend horizontally from the support arm's end point, creating a stable platform for headset placement. One design of the member 8 includes a ridge shaped as an A-frame, which is a raised linear protrusion that extends along a portion of the retention member. It is positioned to interact with a or groove found on the headset. When the headset is placed onto the member, the ridge fits into the corresponding groove, effectively reducing lateral and vertical movement of the headset and thus securing it in place. This prevents the headset from slipping off unintentionally during use. The geometry of the ridge is designed in such a way that it conforms to the external surface contour of the headset, ensuring a tight fit and immobilization against unwanted motion. Alternatively, the retention member can feature a roof structure. This design resembles an inverted ‘V’ or a peaked shape that provides a cradle for the headset. The roof structure is characterized by two sloping sides converging at a peak or apex, where these sloping sides match the contour of the headset's surfaces they come in contact with. When the headset is positioned within this structure, the sloping sides provide a downwards force due to the headset's weight, enhancing the grip and holding the headset firmly in place. The roof structure thereby forms a stable support, with the angle and dimensions of the slopes tailored to the specific dimensions of the headset to ensure an optimum hold.

Together, the hook 2, arm 4, and retention member 8 provide the necessary balance to the hook during operation. The alignment ensures that any weight applied to the hook is effectively transferred and distributed along the support arm, minimizing the risk of stress or damage to the structure. The connection point where the support arm meets the hook section withstands bending, twisting, or any other form of distortion.

The device also includes the cable support hook 6. When attached to the support arm, it helps in management and structuring of cables and wires. This hook is crafted to firmly retain cables, decreasing mess and preserving a systematic configuration. The cable support hook is constructed from materials chosen for their durability, strength, and low electrical conductivity to eliminate any disruption in cable function. One implementation includes protective layers or components like plastic liners or rubberized grips to safeguard the insulation of the cables it holds.

The device of FIG. 1A-1C is specifically made to hold an aviation headset and hang it from the standard spec visor rail in an aircraft. This visor rail is commonly manufactured by Rosen Aviation. The rail measures ⅝″ in diameter. The device has a clip that interfaces with this rail to hold it securely and minimize movement with the repeatability of use also in mind so the clip can be attached and removed numerous times. The support arm 4-5 is precision engineered to hold an aviation headset securely and balanced on this device so that it does not fall forward, backward, or to the side. The design elements include a balance angle in the support arm to center the headset below the rail, a lip 9 at the end of the support member to contain the headset, the length of the support arms to ensure there is sufficient clearance for the headband of the headset to easily be attached and removed from the device with minimal effort while being as compact as possible to keep the headset system organized while in use, the width of the device itself to fit between the comfort pads on the headband of the headset so that it does not interfere or cause wear to them, the cable clip 6 to attach the hook semi-permanently to the cable to aid the user in remembering to collect the device after use and aid in organization, the overall dimensions of the device to not take up unnecessary room in the user's headset protective case when stored. This was achieved through trial and error and design iterations over months of real-world use by several users. Dimensions of two different hook designs are provided. Example dimensions of two different headset headbands are 16 mm thick×45 mm wide and 22 mm thick×27 mm wide.

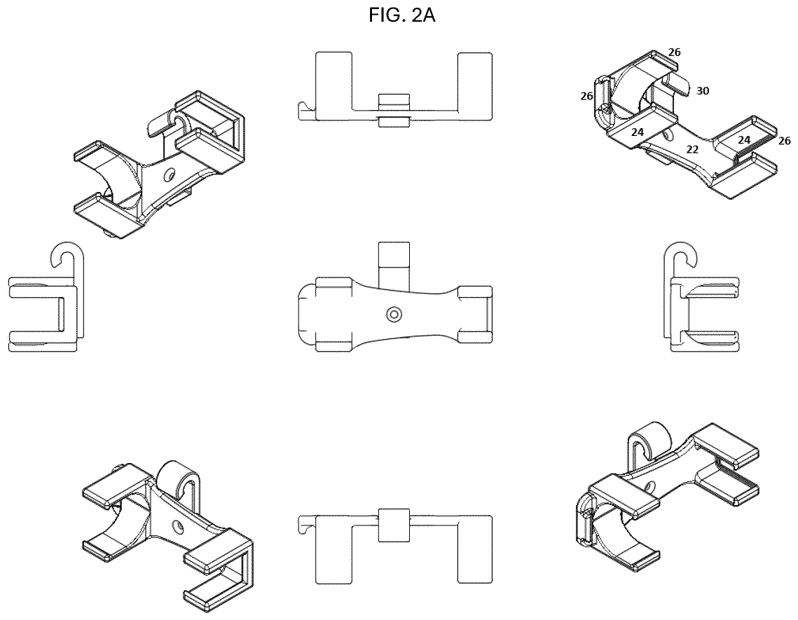

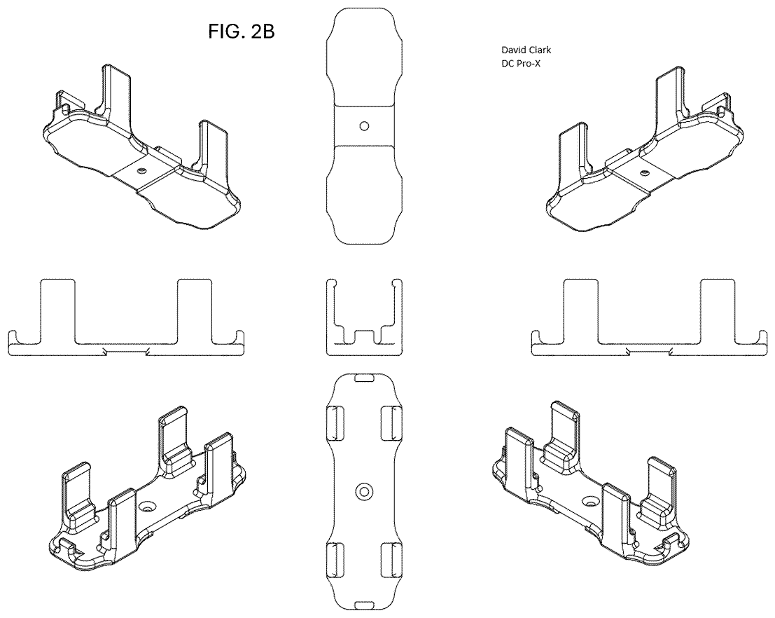

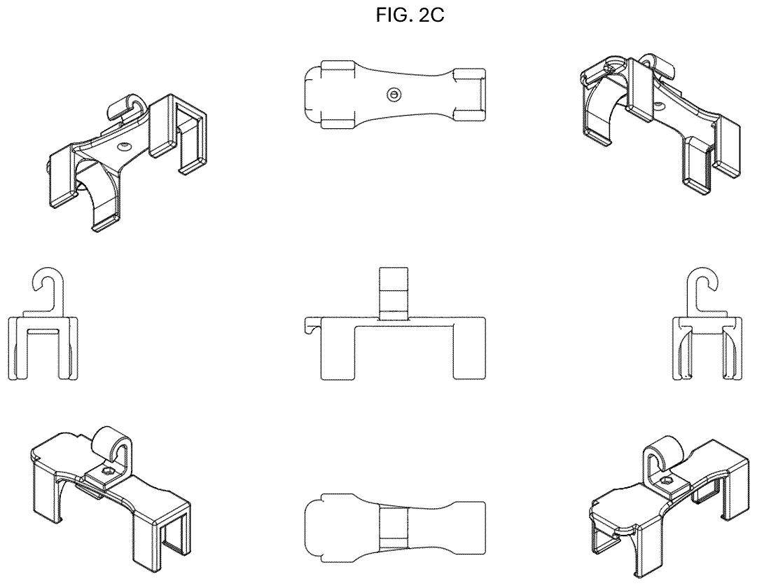

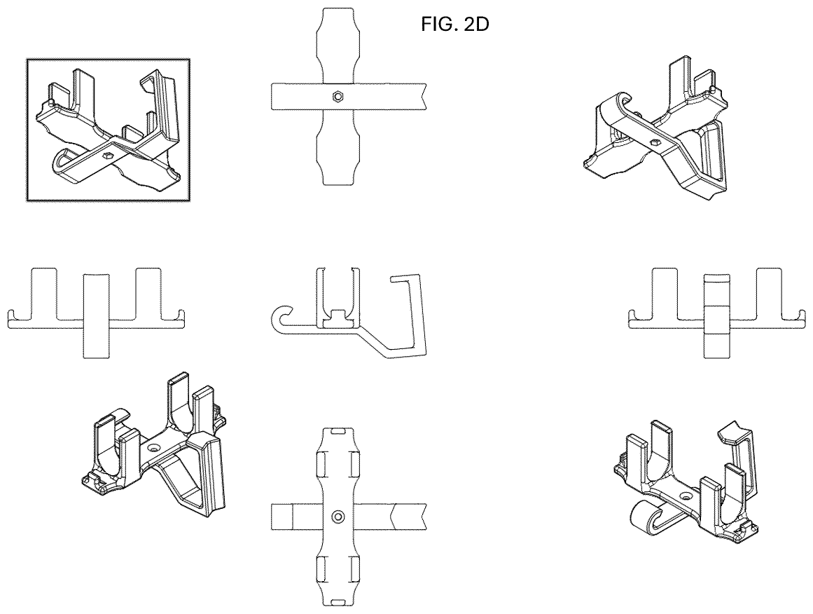

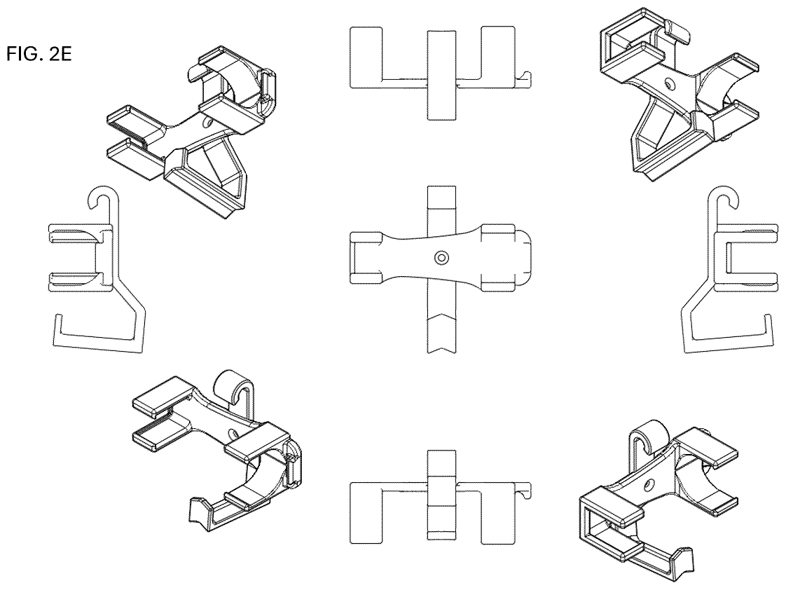

The headset is managed by its controller and the controller is also supported using the mount of FIGS. 2A-2D. The aviation headset controller incorporates comprehensive audio management capabilities through an integrated control interface that enables adjustment of multiple audio parameters. The system features independent volume controls for both left and right ear cups, allowing pilots to fine-tune their listening experience based on individual preferences or specific cockpit conditions. The controller houses critical operational switches within its battery compartment, including BT-AUX priority selection for managing Bluetooth and auxiliary inputs, as well as configurable settings for mono/stereo intercom operation.

Typically a headset works in conjunction with a headset controller and they are interconnected by way of a cable. In another aspect, the headset controller of FIGS. 1A-1C works in conjunction with a controller mount device shown in FIGS. 2A-2E, each customized to a particular controller design so that the hand controller is also secured to the visor rail via a hook.

The controller mount grips onto the visor rail using a clipping mechanism that ensures a firm hold once engaged. This clip-on feature allows for quick and effortless installation or removal, providing adaptability to differing cockpit configurations or user preferences. Upon engagement, the mount device functions as an anchor point for securing the controller. The controller is tethered by a cable that allows for the transmission of signals from the controller to the associated systems. To ensure that the cable does not dangle loosely, a cable support hook is strategically positioned on the hook 6 of support arm 4.

The controller retention member features a base with up to four arms extending outward. The design of the retention member is such that it provides ample support to a variety of controller shapes and sizes. Each of these arms functions together with the others to distribute the weight of the controller evenly by holding a corner or a section of the controller, thereby maintaining stability and balance of the controller.

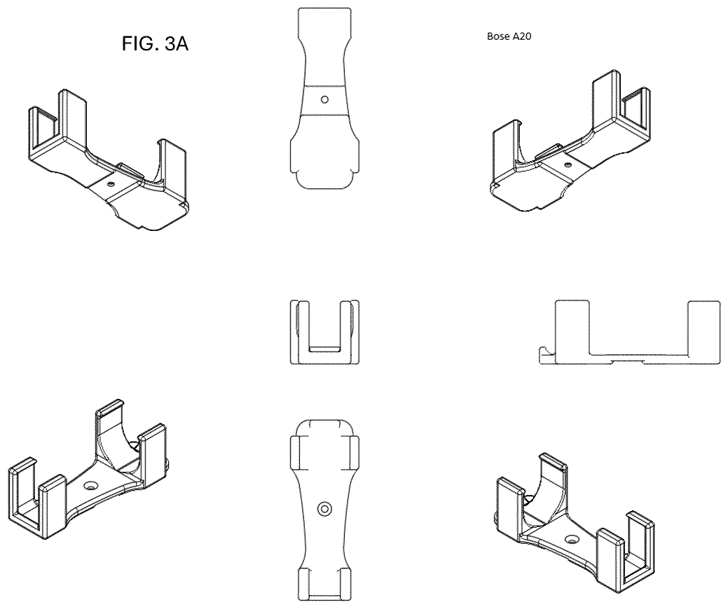

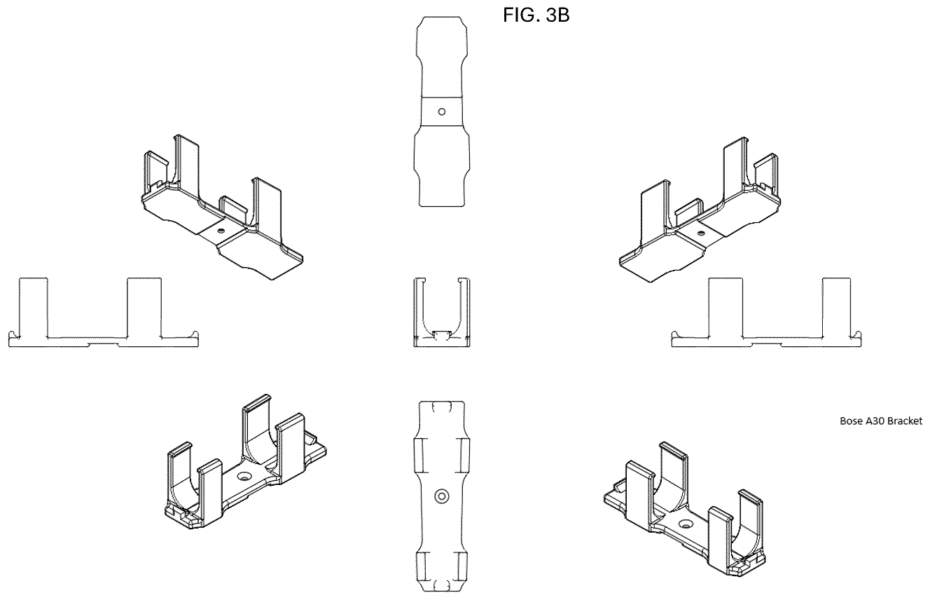

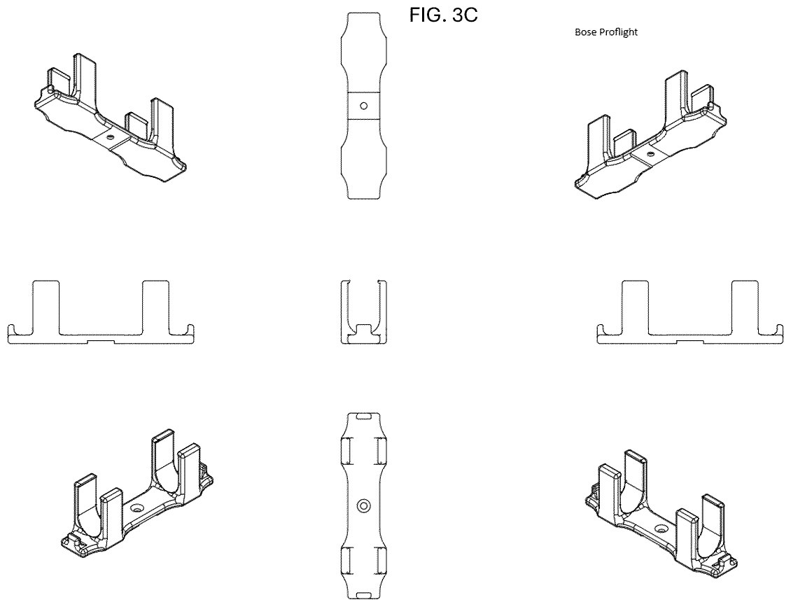

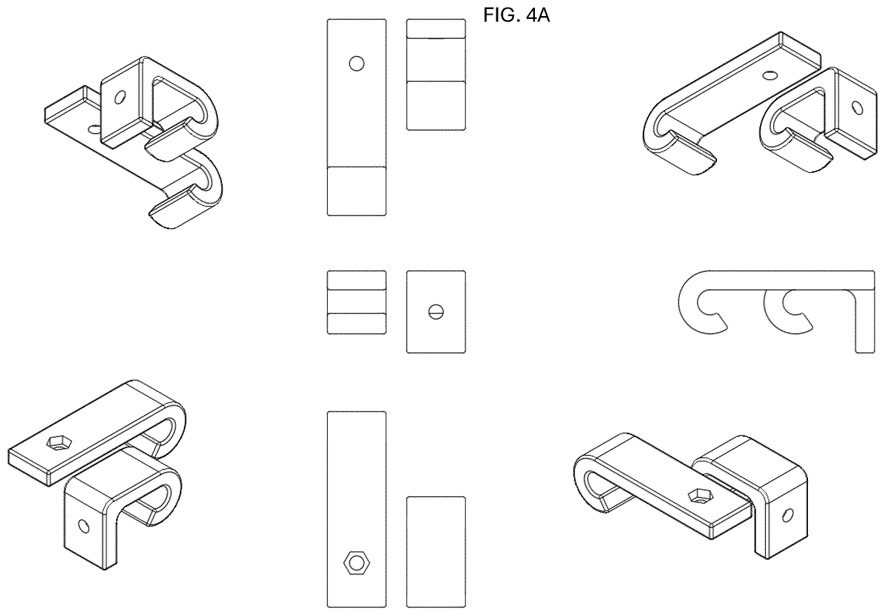

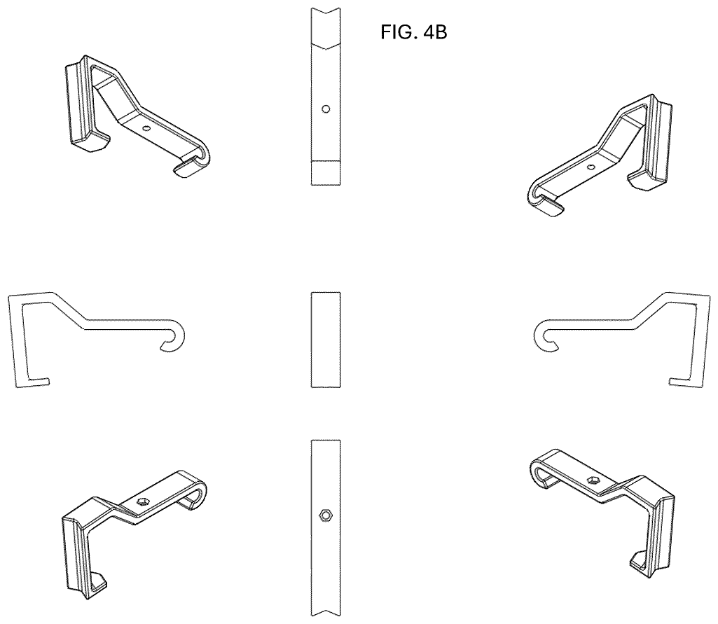

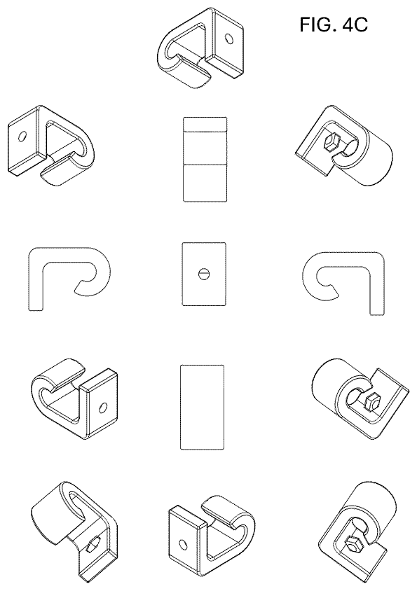

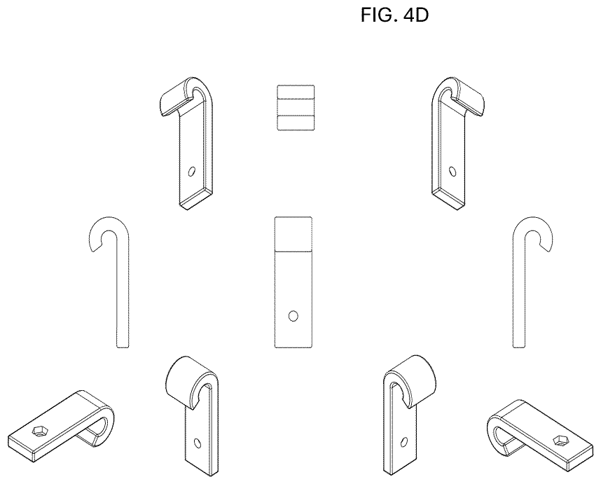

As exemplified in FIG. 2A, the headset cable supported by hook 6 goes into a controller secured by a controller retention member mounted on the visor arm, wherein the controller retention member includes a hook 30 that is rotatably secured to a base 22 with two or more arms 24 extending therefrom to secure and balance the controller on the controller retention member. Preferably four arms 24 are used to secure the controller. Optionally, at the end of the base 22, an end plate or lip 26 can be used to prevent slippage by the controller outside of the base 22. Individual variations of bases 22 are shown in FIGS. 3A-3C, while an exemplary controller hook portion 30 is shown in FIG. 4A-4D.

The controller mounting system features a custom-designed base structure 22 that accommodates specific aviation headset controller form factors. The base incorporates precision-engineered mounting surfaces with up to four extension arms that extend outward from the central body. These arms are strategically positioned to create a secure clip-fit mechanism that firmly grasps the controller body while allowing for easy installation and removal. The hook component is integrated into the base through a rotatable connection point, enabling 360-degree rotation capability for optimal positioning, secure locking positions at predetermined angles, smooth transitional movement between positions and self-centering functionality to maintain stability. The four extension arms exhibit several design features such as symmetrical arrangement around the base perimeter, curved contact surfaces to prevent controller damage, integrated retention lips at arm terminals, spring-like flexibility for secure gripping action, and reinforced attachment points to the base structure.

The mount devices can be used by attaching a headset mount device to a visor rail in the aircraft and engaging a hook portion of the bracket with the rail, wherein the hook extends into a support arm pointing toward a cockpit window, wherein the support arm further extends into a headset retention member with a tip pointing away from the cockpit window; and placing a headset on a headset retention member on the visor rail with a headset cable coupled to the support arm, wherein the headset retention member is configured to secure and balance a headset on the headset retention member. Optionally a controller mount device can be clipped to the visor rail and securing a controller on the support arm. The user can thread a cable between the headset and the controller through a cable support hook on the support arm.

The system accommodates various controller body designs through: adjustable grip pressure via the extension arm geometry, custom contact surfaces matching controller contours, placement of retention points to avoid interference with controls, and clearance zones for cable routing and connector access.

The support system is made from durable materials that can withstand the wear and tear commonly found in aircraft environments. Its components can be adjusted in position and orientation to meet the user's needs or fit the cockpit layout, providing flexibility and making it suitable for use across various aircraft models.

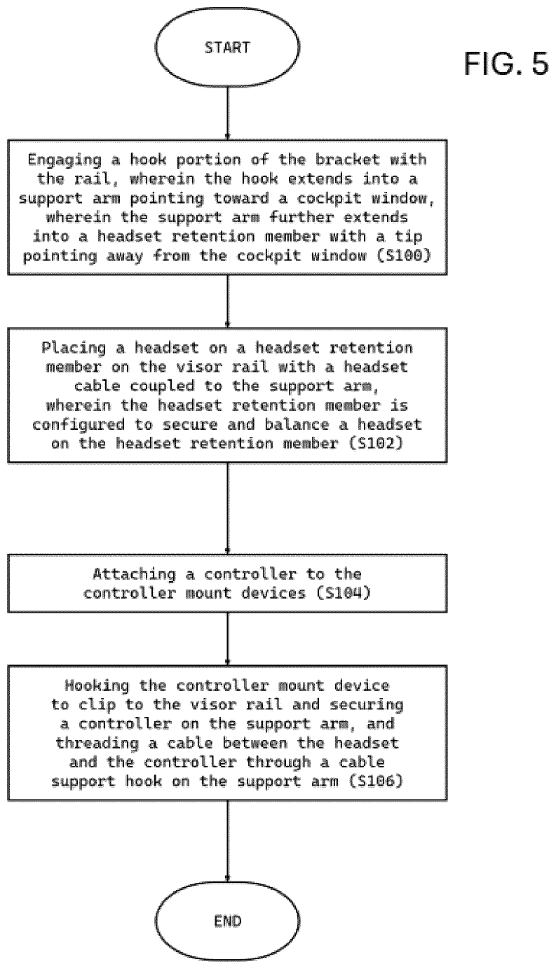

FIG. 5 shows an exemplary process or method to use the mount devices of FIGS. 1A-1C and 2A-2E. The method includes attaching a headset mount device to a visor rail in the aircraft by:
engaging a hook portion of the bracket with the rail, wherein the hook extends into a support arm pointing toward a cockpit window, wherein the support arm further extends into a headset retention member with a tip pointing away from the cockpit window;
placing a headset on a headset retention member on the visor rail with a headset cable coupled to the support arm, wherein the headset retention member is configured to secure and balance a headset on the headset retention member;
attaching a controller to the controller mount devices;
hooking the controller mount device to clip to the visor rail and securing a controller on the support arm, and
threading a cable between the headset and the controller through a cable support hook on the support arm.

The above headset clip has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1. A headset mount device for attachment to an airplane visor rail, comprising:
a hook portion configured to engage with the airplane visor rail;
a support arm extending from the hook portion; and
a headset retention member coupled to the support arm, wherein the headset retention member is configured to secure and balance a headset on the headset retention member.

2. The device of claim 1, wherein the hook portion comprises a curved section adapted to partially encircle the visor rail.

3. The device of claim 1, wherein the support arm extends substantially perpendicular to the hook portion.

4. The device of claim 1, wherein the headset retention member comprises a substantially flat surface for supporting the headset.

5. The device of claim 1, wherein the headset retention member comprises a ridge, an A-frame, or a roof shape to support the headset, and wherein the headset retention member comprises an extension or stopper at the end to prevent headset slippage.

6. The device of claim 1, comprising a cable support hook coupled to the support arm.

7. The device of claim 1, comprising an extension or stopper at one end of the support arm to prevent headset slippage.

8. The device of claim 1, comprising a controller mount device to clip to the visor rail and spaced apart from the headset mount device, the controller mount device securing a controller with a cable coupled to a cable support hook on the support arm.

9. The device of claim 8, comprising:
a hook portion configured to engage with the visor rail;
a support arm extending from the hook portion; and
a controller retention member coupled to the support arm, wherein the controller retention member includes a base with four arms extending therefrom to secure and balance the controller on the controller retention member.

10. The device of claim 9, comprising a stop surface at the end of the base to prevent controller slippage.

11. A headset support device for an aircraft, comprising:
a headset mount device for attachment to an airplane visor rail including a hook portion configured to engage with the visor rail;
a support arm extending from the hook portion;
a headset retention member coupled to the support arm, wherein the headset retention member is configured to secure and balance a headset on the headset retention member;
a controller mount device including a hook portion configured to engage with the visor rail;
a support arm extending from the hook portion; and
a controller retention member coupled to the visor rail with a controller hook, wherein the controller hook is rotatably coupled to a base with four arms extending therefrom to secure and balance the controller on the controller retention member.

12. The device of claim 11, wherein the hook portion comprises a curved section adapted to partially encircle the visor rail.

13. The device of claim 11, wherein the support arm extends substantially perpendicular to the hook portion.

14. The device of claim 11, wherein the headset retention member comprises a substantially flat surface for supporting the headset.

15. The device of claim 11, wherein the headset retention member comprises a ridge, an A-frame, or a roof shape to support the headset, and wherein the headset retention member comprises an extension or stopper at the end to prevent headset slippage and further comprising an extension or stopper at one end of the support arm to prevent headset slippage.

16. The device of claim 11, comprising a cable support hook coupled to the support arm.

17. A method of using a headset support system in an aircraft, comprising:
attaching a headset mount device to a visor rail in the aircraft by engaging a hook portion of the bracket with the rail, wherein the hook extends into a support arm pointing toward a cockpit window, wherein the support arm further extends into a headset retention member with a tip pointing away from the cockpit window; and
placing a headset on a headset retention member on the visor rail with a headset cable coupled to the support arm, wherein the headset retention member is configured to secure and balance a headset on the headset retention member.

18. The method of claim 17, comprising hooking a controller mount device to clip to the visor rail and securing a controller on the support arm, further comprising threading a cable between the headset and the controller through a cable support hook on the support arm.

19. The method of claim 18, wherein the controller mount device comprises:
a hook portion configured to engage with the visor rail;
a support arm extending from the hook portion; and
a controller retention member coupled to the support arm, wherein the controller retention member includes a base with four arms extending therefrom to secure and balance the controller on the controller retention member.
